(19) United States
(12) Patent Application Publication
(10) Pub. No.: US 2023/0061448 A1
(43) Pub. Date: Mar. 2, 2023

(54) Integrated Module Having Multiple Optical Channel Monitors With Shared Liquid Crystal Based Switching Assembly

(71) Applicant: II-VI Delaware, Inc., Wilmington, DE (US)

(72) Inventors: Guomin JIANG, Campbell, CA (US); Helen CHEN, Cupertino, CA (US); Xuewen LU, San Jose, CA (US); Lixin WANG, Fremont, CA (US); Qingyu LI, Cupertino, CA (US); Haiji YUAN, Cupertino, CA (US); Yimin JI, Irvine, CA (US); Wenyi CAO, Shanghai (CN)

(21) Appl. No.: 18/048,139

(22) Filed: Oct. 20, 2022

Related U.S. Application Data
(63) Continuation of application No. 17/244,296, filed on Apr. 29, 2021.
Application No. 17/244,296 is a continuation of application No. PCT/CN2021/076433, filed on Feb. 10, 2021.

(51) Int. Cl. G02B 6/35; H04B 10/2513

(52) U.S. Cl. CPC G02B 6/356; H04B 10/2513

(57) ABSTRACT

A module handles beams having multiple channels in an optical network. The module has a dispersion element, a liquid crystal (LC) based switching assembly, and photodetectors. The dispersion element is arranged in optical communication with the beams from inputs and is configured to disperse the beams into the channels across a dispersion direction. The switching assembly is arranged in optical communication with the channels from the dispersion element and is configured to selectively reflect the channels using electrically switchable cells of one or more LC-based switching engines. The photodetectors are arranged in optical communication with the dispersion element, and each are configured to receive selectively reflected channels for optical channel monitoring. Outputs can be arranged in optical communication with the dispersion element and can be configured to receive selectively reflected channels for wavelength selective switching.

### PRIORITY INFORMATION

This application is a continuation of Ser. No. 17/244,296, filed Apr. 29, 2021, which is a continuation of PCT/CN2021/076433, filed Feb. 10, 2021, the entire contents of each of which are hereby incorporated by reference herein.

### FIELD OF THE DISCLOSURE

The present disclosure is directed to an integrated module having multiple optical channel monitors (OCMs) that share a switching assembly having a liquid crystal (LC)-based engine. The integrated module can further integrate wavelength selective switching with the optical channel monitoring and can achieve parallel detection or other forms of detection.

### BACKGROUND OF THE DISCLOSURE

Fiber optic networks use wavelength-division multiplexing (WDM) signals carried on optical fibers for fiber optic communications. Optical channel monitoring is used in the fiber optic network to monitor the spectral characteristics of the composite signal at particular points in the network. Information from this monitoring can then be used to optimize the performance of the network.

Some of the components used for optical channel monitoring include photodetectors and switches. A Digital Micromirror Device (DMD) is one type of switch used in optical networks. This device has a MEMS array of silicon mirrors that can be moved in a range of tilt angles to direct channels to desired ports. The mirrors can be individually and independently movable using an analog high-voltage MEMS driver circuit.

There is always a desire to reduce the complexity of components in an optical network, to reduce the number of port connections and separate housings needed, and to reduce the costs for the network components. To that end, the subject matter of the present disclosure is directed to overcoming, or at least reducing the effects of, one or more of the problems set forth above.

### SUMMARY OF THE DISCLOSURE

According to one arrangement of the present disclosure, a module is used for handling optical beams in an optical network. Each of the optical beams has a plurality of optical channels. The module comprises a plurality of first input ports for the optical beams, a dispersion element, a switching assembly, and one or more photodetectors. As an example, the module can be used for optical channel monitoring of wavelength-division multiplexing (WDM) signals for a fiber optic network.

The dispersion element, which can be a diffraction grating, is arranged in optical communication with the optical beams from the first input ports and is configured to disperse the optical beams into the optical channels across a dispersion direction.

The switching assembly is arranged in optical communication with the optical channels from the dispersion element and is configured to selectively reflect the optical channels. The switching assembly comprises at least one switch engine being liquid crystal based and having a first array of first cells arranged in the dispersion direction for respective ones of the optical channels. For example, the at least one switch engine can be a liquid crystal (LC) switch engine or a liquid-crystal-on-silicon (LCoS) switch engine. One or more LC switch engines can be stacked together and can have other optical elements, such as reflectors, polarizers, etc.

Each of the first cells is electrically switchable between first and second states. Each of the first cells in the first state is configured to at least pass the respective optical channel, and each of the first cells in the second state is configured to at least attenuate the respective optical channel.

The one or more photodetectors are arranged in optical communication with the dispersion element. Each of the one or more photodetectors is configured to receive one or more of the optical channels selectively reflected from the switching assembly for optical channel monitoring of a respective one or more of the first input ports.

According to another arrangement of the present disclosure, a module is used for handling optical beams in an optical network. Each of the optical beams having a plurality of optical channels. As an example, the module can be used for optical channel monitoring and wavelength selective switching of wavelength-division multiplexing (WDM) signals for a fiber optic network.

The module comprises: a plurality of first input ports for the optical beams; and one or more second input ports for the optical beams. A dispersion element, such as a diffraction grating, is arranged in optical communication with the optical beams from the first input ports and the one or more second input ports. The dispersion element is configured to disperse the optical beams into the optical channels across a dispersion direction.

A switching assembly is arranged in optical communication with the optical channels from the dispersion element and is configured to selectively reflect the optical channels using at least one switch engine. One or more photodetectors are arranged in optical communication with the dispersion element. Each of the one or more photodetectors are configured to receive one or more of the optical channels selectively reflected from the switching assembly for optical channel monitoring of a respective one or more of the first input ports. One or more output ports are arranged in optical communication with the dispersion element and are configured to receive one or more of the optical channels selectively reflected from the switching assembly for wavelength selective switching of the one or more second input ports.

The foregoing summary is not intended to summarize each potential embodiment or every aspect of the present disclosure.

### BRIEF DESCRIPTION OF THE DRAWINGS

FIGS. 1A-1C illustrate schematic views of modules having multiple optical channel monitors integrated with a shared switching assembly.

FIGS. 2A-2B illustrate schematic views of a liquid crystal-based switching engine for the disclosed switching assembly.

FIGS. 3A-3B illustrate schematic views of additional configurations for the liquid crystal-based switching engine of the disclosed switching assembly.

FIG. 4A illustrates a configuration of an integrated module according to the present disclosure viewed in a port direction.

FIG. 4B illustrates the configuration of FIG. 4A viewed in a dispersion direction.

FIG. 5A illustrates an integrated module having multiple wavelength selective switches and optical channel monitors for broadcast and select operation.

FIG. 5B illustrates another integrated module having multiple wavelength selective switches and optical channel monitors for route and select operation.

FIG. 6 illustrates a configuration of an integrated module for wavelength selective switching and optical channel monitoring according to the present disclosure.

FIG. 7A illustrates the configuration of FIG. 6 viewed in a port direction.

FIG. 7B illustrates the configuration of FIG. 6 viewed in a dispersion direction.

FIGS. 8A-8B illustrate a face of a switching assembly having switch engines with different configurations for electrical routing.

### DETAILED DESCRIPTION OF THE DISCLOSURE

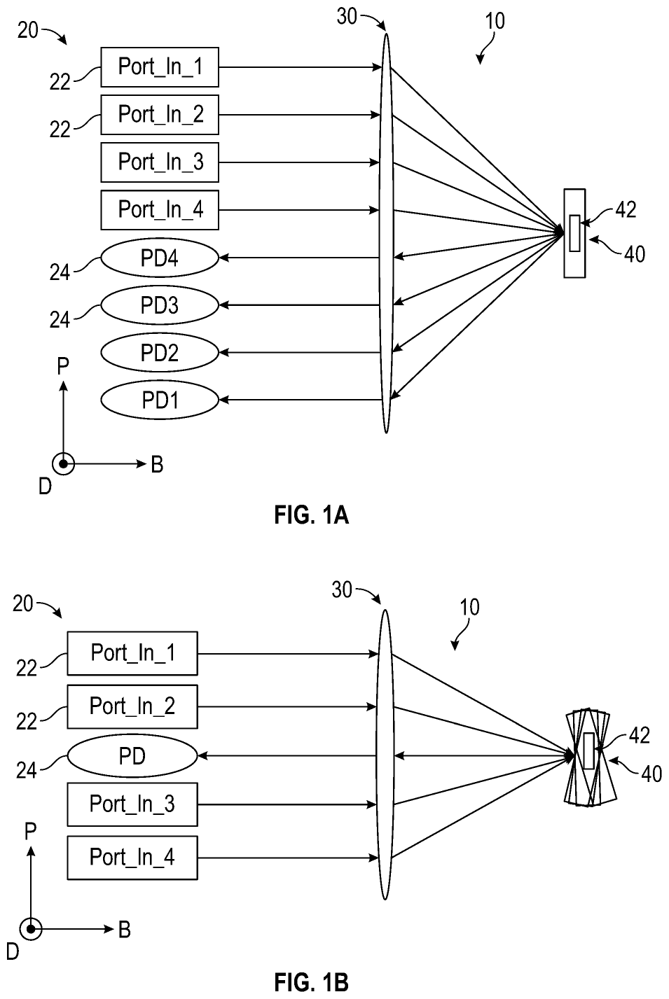

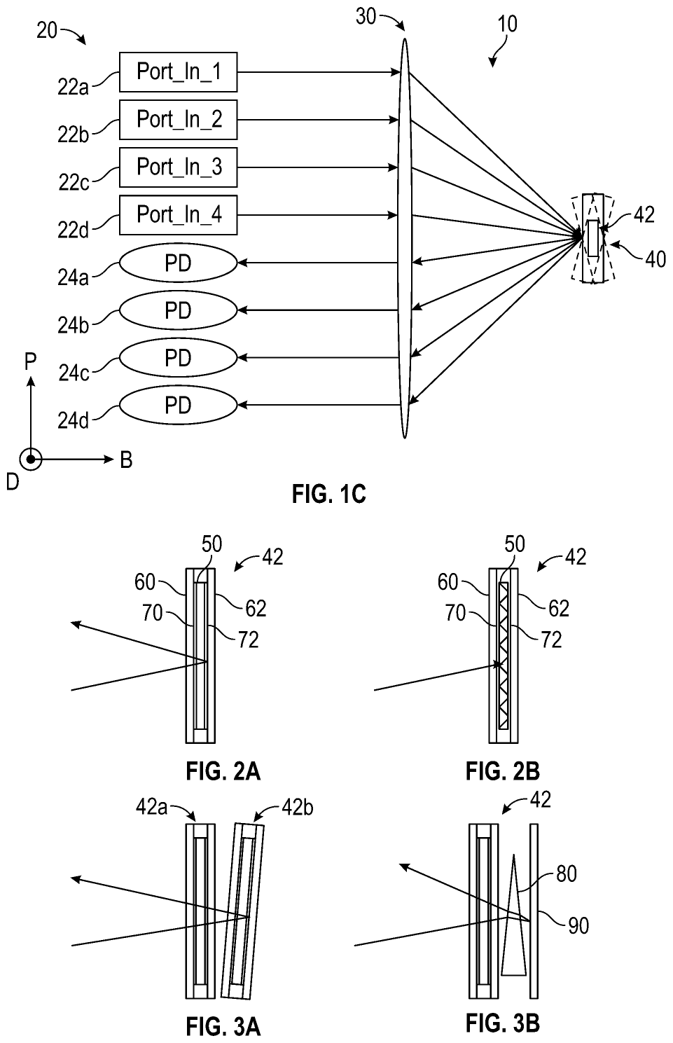

FIG. 1A illustrates a schematic view of a module 10 having multiple optical channel monitors 20, which includes input ports 22 and photodetectors 24 integrated with a shared diffusion element 30 and a shared switching assembly 40. The input ports 22 are shown relative to photodetectors 24, and the diffusion element 30 is disposed in the optical path between the monitors 20 and the switching assembly 40. The diffusion element 30 can include a diffraction grating, one or more lenses, and other components to disperse and direct different wavelengths of wavelength-division multiplexing (WDM) signals of a fiber optic network. Collimators and other conventional components are not shown for simplicity.

The photodetectors 24 are used in the optical channel monitors 20 to measure power levels and possibly other signal parameters of an optical channel that is directed from a corresponding input port 22 to the photodetector 24. In the current arrangement, the module 10 provides for parallel detection by the optical channel monitors 20 so that multiple channels can be scanned simultaneously in parallel detection for the optical channel monitoring using the shared switching assembly 40. To do this, the shared switching assembly 40 includes a liquid crystal (LC)-based switch engine 42 having a single control window or array of cells. The LC-based switch engine 42 is operated to route (by selective reflection) the optical channels for parallel detection with the multiple monitors 20.

FIG. 1B illustrates a schematic view of another module 10 having multiple optical channel monitors 20 integrated with the shared switching assembly 40. In contrast to the arrangement of FIG. 1A, the monitors 20 include multiple ports 22 relative to a common photodetector 24. The shared switching assembly 40 is configured to route (by selective reflection) optical channels from the inputs 22 to the common photodetector 24.

In this arrangement, the module 10 provides for sequential detection. Here, the multiple ports 22 relative to the photodetector 24 are arranged for sequential detection by virtually using an N×1 wavelength selective switch and one photodetector 24 for multiple monitors 20. In this approach, only one channel on one port 22 can be detected at any given moment so the response times may be N times slower. This may have benefits in some optical networks, but not others. The single photodetector 24 and sequential detection scheme can be used to further reduce cost when slower scan speed is allowed. Port switching can be added to further speed up the scan speed.

FIG. 1C illustrates a schematic view of yet another module 10 having multiple optical channel monitors 20 integrated with the shared switching assembly 40. In contrast to the arrangements of FIGS. 1A-1B, the monitors 20 include multiple ports 22 relative to several shared photodetectors 24. The shared switching assembly 40 is configured to route (by selective reflection) optical channels from the inputs 22 to multiple ones of the photodetectors 24.

This module 10 provides for reconfigurable detection and channel assignment. In particular, operation of the LC-based switch engine 42 can configure which of the photodetectors 24a-d receives the optical channel from which of the given ports 22a-d. In this way, assignments of the photodetectors 24a-d to each channel to be monitored is reconfigurable so the OCM scan speed can be reconfigured based on network needs. This reconfigurability also allows quick recovery because controls can switch the various photodetectors 24a-d to different channels for monitoring should some failure occur.

This configuration allows for different channel assignments to be used. For example, multiple photodetectors 24a-d can be used in the detection of a channel wavelength during a scan cycle. In the scan cycle, for example, the three photodetectors 24a-c can detect portions of one channel wavelength.

The configuration also allows for reconfigurable detection to be used. Any photodetector 24a-d can be reconfigured to any input port 22a-d based on the network needs. Channels can be grouped according to the photodetector reconfiguration. For example, three photodetectors 24a-c can be assigned to channels on one OCM port 22a so that the scan time will be three times faster. The other photodetector 22d is reconfigured for the other three OCM ports 22b-c.

In each of the LC-based switch engines 42 disclosed above and elsewhere herein, the engine 42 may have one or more LC-based layers for routing. Overall, adding an additional LC-based layer can double the port count for the engine 42 and may only introduce about 0.3 dB extra loss.

Some general details of the LC-based switch engines 42 will now be described. FIGS. 2A-2B illustrate schematic views of an LC-based switching engine 42. In general, the LC-based switching engine 42 can be a liquid crystal (LC) switching engine or a liquid-crystal-on-silicon (LCoS) switching engine.

As only schematically shown here, liquid crystal material 50 is confined between substrates 60, 62. Electrodes 70, 72, one of which can be continuous and the other of which can be patterned as pixels, can be independently controlled by voltages applied to alter/switch the birefringence of the LC material 50 between at least two states (a first state in FIG. 2A to pass light and a second state in FIG. 2B to at least attenuate or block light). This arrangement in FIGS. 2A-2B may generally represent an LC switching engine.

The LC-based switching engine 42 used for optical channel monitoring may generally include an “on” or “pass” state and an “off” or “block” state. In the “on” or “pass” state, incident light can pass through liquid crystal material 50 to be reflected by the assembly. In the “off” or “block” state, incident light cannot pass through the assembly. Strictly speaking, the light can always pass through liquid crystal material 50. For an LC switch engine, the polarization state of input light is changed by the material 50, and the polarized light is then blocked by other components, such as a polarizer. For an LCoS switch engine, a phase grating on the LCoS can diffract all or a part of input light to a dumped position for blocking or attenuation the light.

The LC-based switching engine used for wavelength selective switching may generally include graded states of attenuation including and between an “on” or “pass” state and an “off” or “block” state. As such, intermediate states can be used to intermediately attenuate light.

As an LC switching engine, the component 42 may have an array of LC pixels arranged in one or more dimensions on the substrate. As an liquid-crystal-on-silicon (LCoS) switching engine, the component 42 may have a two-dimensional (2D) array of pixels on a silicon substrate with CMOS circuitry (not shown) used for controlling the pixels. In the LCoS switching engine, for example, the component 42 can have the LC material 50 sandwiched between a transparent glass layer 60 (having a transparent electrode 70) and a silicon substrate 62 (divided into a two-dimensional array of individually drivable pixels). A voltage signal provides a local phase change to an optical signal, thereby offering a two-dimensional array of phase manipulating regions.

In both of these types of switching engines 42, the electrodes 70, 72 for the pixels can be finely patterned. The gap between pixels can be very small, and the LC material 50 can be a continuous medium in the engine 42. The electric field applied by the pixel's electrodes 70, 72 to the birefringent LC material 50 varies the orientation of the crystals to direct the path of an optical beam. In this way, individual spectral components spatially separated by a diffractive element, such as the diffraction grating (120: FIGS. 1A-1C), can be manipulated at predetermined regions of the engine 40 depending on the LC material's birefringent state of the associated region.

As shown in the assembly 140 of FIG. 3A, multiple LC-based engines 42a-b can be arranged in layers aligned behind one another in a propagation direction of the light so that the light can be configured to pass through one or more of the layers of the engines 42a-b. Only two layers of engines 42a-b are shown here as an example, but more could be used. In general, each of LC-based engines 42a-b can be an LC switching engine. Alternatively, any front LC-based engine 42a can be an LC switching engine that may allow for passage of light, while the back-most engine 42b can be an LCoS switching engine.

As shown in FIG. 3B, additional optics can be used with the engine 42. For example, wedge angles, prisms, reflectors, mirrors, polarizers, gratings, or other optical components can be used for beam steering and the like. A prism 80 is shown here along with a reflective mirror 90. The reflective mirror 90 can be angled to direct reflected beams back along a desired path.

The assembly 40 of the present disclosure can use one or more of these LC-based engines 42. Moreover, the LC-based engines 42 of the present disclosure can be based on these configurations as well as other configurations available in the art.

With a general understanding of how a shared switching assembly 40 having an LC-based switch engine 42 can be used with input ports and photodetectors of optical channel monitors, discussion turns to more details of the configurations in an integrated module.

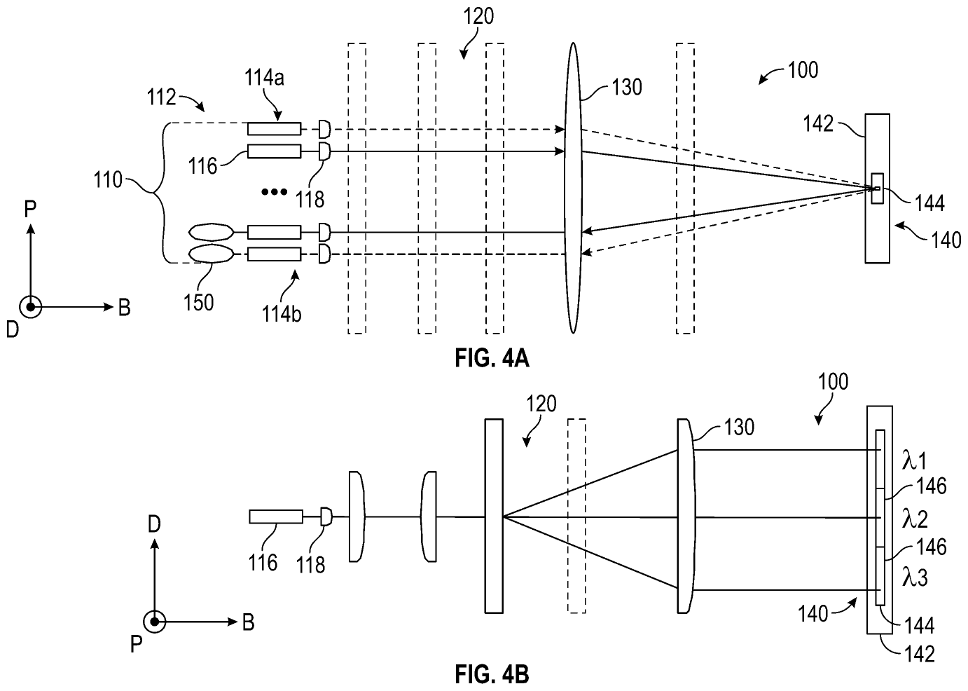

FIG. 4A illustrates a configuration of an integrated module 100 according to the present disclosure viewed in a port direction (i.e., viewed to show the stacking of ports), and FIG. 4B illustrates the configuration of the integrated module 100 of FIG. 4A viewed in a dispersion direction (i.e., viewed to show the dispersion of optical channels).

The module 100 includes multiple optical channel monitors 110 integrated with a shared switching assembly 140. A dispersion element 120, such as a diffraction grating or a prism, and one or more lenses 130 are disposed in the optical path between the channel ports 112 of the monitors 110 and an LC-based switch engine 142 of the switching assembly 140 having a control window or array 144 of cells.

The channel ports 112 include input ports 114a having fibers 116 for optical beams, which are collimated by collimators 118. The channel ports 112 also include output ports 114b having fibers 116 for optical beams, which have been collimated by collimators 118. These output ports 114b are optically coupled to photodetectors 150 of the optical channel monitors 110 for performing the optical channel monitoring as disclosed herein.

The collimators 118 may be an aspherical lens, an achromatic lens, a doublet, a GRIN lens, a laser diode doublet, or similar collimating lens. From the input fibers 114a and collimators 118, a collimated input signal is incident on the light dispersion element 120 (e.g., a diffraction grating or a prism), which spatially separates the optical channels of the collimated input signal by diffracting or dispersing the light from (or through) the light dispersion element 120. The spatial separation of the optical channels is shown in FIG. 4B.

One or more lens 130 then focus the optical channels to the switching assembly 140, which acts as a common switch for the monitors 110. The switching assembly 140 includes one or more LC-based switch engines 142, which can be an LC switching engine or an LCoS switching engine as disclosed herein. As shown here, the assembly 140 can have one LC-based switch engine 142. However, the assembly 140 can have several engines 142 stacked in layers in a propagation direction of the beams as noted herein. As best shown in the dispersion direction of FIG. 4B, the switch engine 142 includes a control window or array 144 with multiple cells 146 arranged in the dispersion direction (D). Here, in this simplified example, only three cells 146 are shown for three channels. These cells 146 are selectively operable between at least first and second states in the manner disclosed herein to selectively route (by reflection or attenuation) the optical channels incident thereto.

In general, the module 100 can provide optical channel monitoring of multiple channels using the one active window of the switching assembly 140, which saves space and cost. Moreover, the optical channel monitoring of multiple channels can be achieved with a shared switch state or with multiple switch states of the cells 146 of the control window 144. Accordingly, this module 100 can operate according to the various schemes disclosed above in FIGS. 1A-1C.

In particular, the module 100 can preferably operate according to the scheme outlined in FIG. 1A above so that multiple channels can be scanned simultaneously in parallel detection for the optical channel monitoring using the shared switching assembly 140. To monitor the optical channels routed (selectively reflected) by the cells 144, the multiple monitors 110 have the detection ports 114b with the collimators 118 and the fibers 116 optically coupled to the photodetectors 150. The control window 144 of the LC-based switch engine 142 for the assembly 140 routes the optical channels to the photodetectors 150 in the port direction.

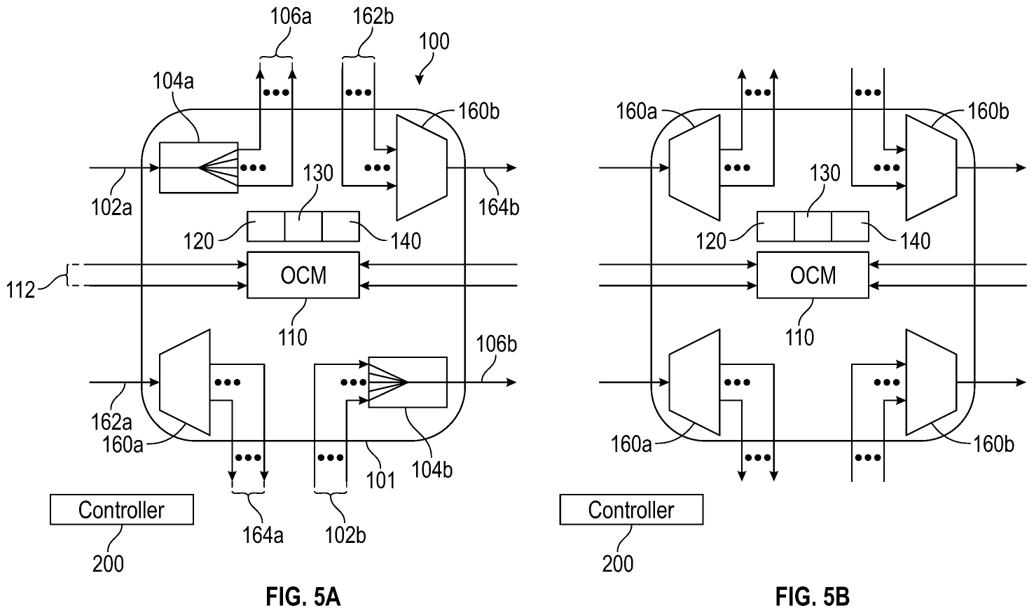

In the configurations above (e.g., with respect to FIGS. 1A-1C and 4A-4B), the modules having one control window of a shared switching assembly with an LC-based switch engine can be used for multiple optical channel monitors. The module of the present disclosure can be used in a number of additional applications. For example, the disclosed module having one switching assembly with an LC-based switch engine can be used for various applications in optical networks, which can have two or four wavelength selective switches and can have a multiple port optical channel monitor. Being able to integrate each of these components into an integrated module can cut down costs and can reduced the component size at the same time. For examples, FIGS. 5A-5B show two possible application configurations of such integrated modules.

In FIG. 5A, an integrated module 100 has multiple wavelength selective switch units 160a-b and a multi-port optical channel monitor unit 110. Additionally and as only schematically shown, the module 100 includes the components of dispersion element 120, lensing 130, and shared switching assembly 140, such as disclosed herein. The module 100 can be used for broadcast and select operations in an optical network so that routed optical signals can be used for the various purposes of the optical network.

Components of the multi-port monitor unit 110 and the wavelength selective switch units 160a-b are housed together in a housing 101. A splitter 104a and a combiner 104b are also housed in the module's housing 101. An input port 102a can split an input signal by the optical splitter 104a into multiple N signals for multiple output ports 106a, and input signals from multiple input ports 102b can be combined by the combiner 104b into an output signal for a common output port 106b. These signals can be used for the various purposes of the optical network.

The wavelength selective switch (WSS) units 160a-b can perform optical switching on a per wavelength channel basis. Accordingly, the WSS units 160a-b can switch any wavelength channel at an input fiber to any desired output fiber. In this way, the 1×N WSS unit 160a can switch any wavelength channel of a WDM input signal propagating along an input fiber of the input 162a to any of the N output fibers coupled to the outputs 164a of the 1×N WSS unit 160a. By contrast, the N×1 WSS unit 160b has multiple inputs 162b and a common output 164b. This N×1 WSS unit 160b can switch any wavelength channel of the WDM input signals propagating along N input fibers for the inputs 162b to the output fiber coupled to the common output 164b of the N×1 WSS unit 160a.

The multi-port optical channel monitor unit 110 has multiple input ports 112 and can include one or more photodetectors (not shown) as noted herein. The input ports 112 receive optical signals so optical channel monitoring can be performed on the WDM signals of the optical network.

In FIG. 5B, another integrated module 100 has multiple wavelength selective switch units 160a-d and a multi-port optical channel monitor unit 110. Additionally and as only schematically shown, the module 100 includes the components of dispersion element 120, lens 130, and shared switching assembly 140, such as disclosed herein. The module 100 can be used for route and select operations in an optical network so that routed optical beams can be used for the purposes of the optical network. Components of the optical channel monitor unit 110 and the wavelength selective switch units 160a-b are housed together in a housing 101.

As before, the wavelength selective switch (WSS) units 160a-b can perform optical switching on a per wavelength channel basis. Accordingly, the WSS units 160a-b can switch any wavelength channel at an input fiber to any desired output fiber. In this way, the 1×N WSS units 160a can switch any wavelength channel of a WDM input signal propagating along an input fiber of the input 162a to any of the N output fibers coupled to the outputs 164a of the WSS units 160a. By contrast, the N×1 WSS units 160b each has multiple inputs 162b and a common output 164b. These N×1 WSS units 160b can switch any wavelength channel of the WDM input signals propagating along N input fibers for the inputs 162b to the output fiber coupled to the output 164b of the WSS units 160b.

As before, the multi-port optical channel monitor unit 110 has multiple input ports 112 and can include one or more photodetectors (not shown) as noted herein. The input ports 112 receive optical signals so optical channel monitoring can be performed on the WDM signals of the optical network.

As the examples of FIGS. 5A-5B show, the disclosed module 100 having one switching assembly with an LC-based switching engine can integrate together two or four wavelength selective switching functions and multiple optical channel monitoring functions, such as in an multi-port optical channel monitoring unit.

In the modules 100 of FIGS. 5A-5B, a controller 200 can be used with the module 100 to control operation. This controller 200 can be an internal component of the module 100, an external component, or a combination of both.

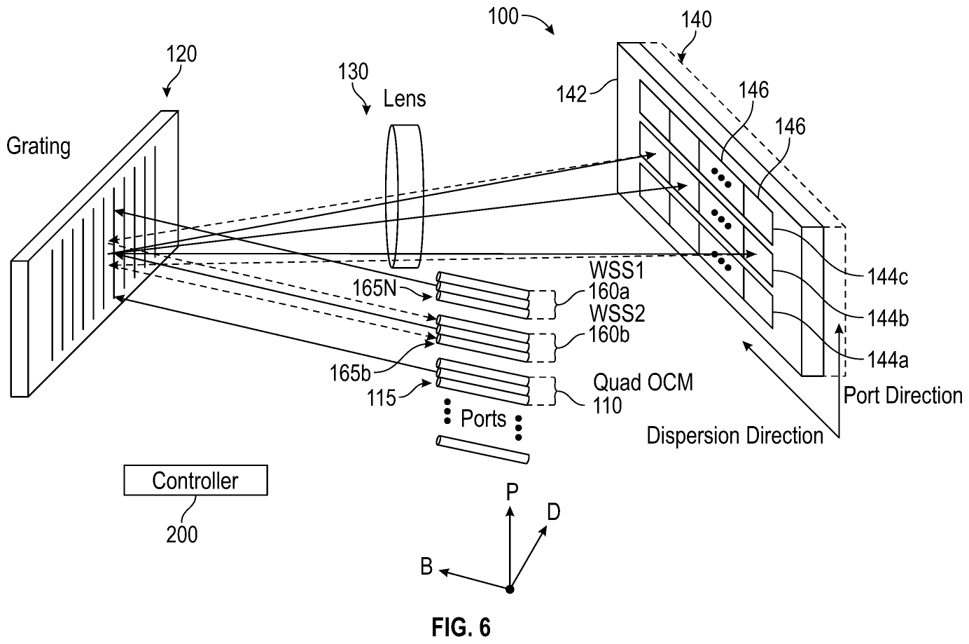

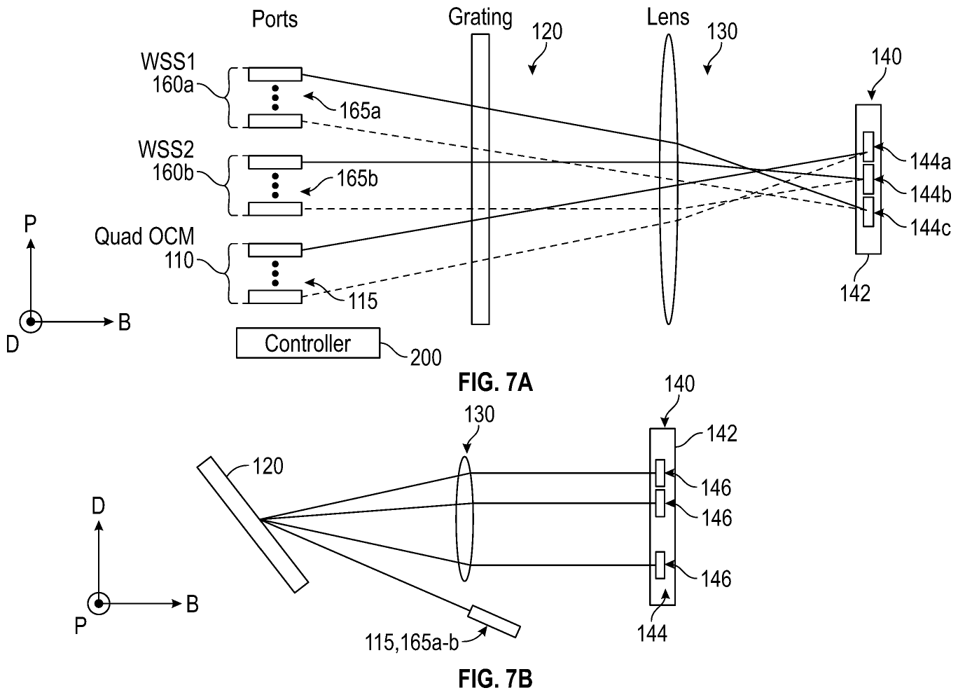

Looking in more detail at an integrated module having combined wavelength selective switching and optical channel monitoring functionalities, FIG. 6 illustrates a configuration of an integrated module 100 for wavelength selective switching and optical channel monitoring according to the present disclosure. The configuration is shown in a 3-dimensional view in a simplified arrangement for clarity. The arrangement includes a multi-port optical channel monitor (i.e., a quad optical channel monitor 110) and includes two wavelength selective switch units 160. For further detail, FIG. 7A illustrates the configuration of FIG. 6 viewed in a port direction, and FIG. 7B illustrates the configuration of FIG. 6 viewed in a dispersion direction.

Ports 115 for the quad optical channel monitor 110 are optically coupled to a dispersion element 120, lensing 130, and a shared switching assembly 140. Ports 165 for the wavelength selective switch units 160 are optically coupled to the dispersion element 120, the lensing 130, and the LC-based switching assembly 140.

As shown here, the switching assembly 140 can have one LC-based switch engine 142. However, the assembly 140 can have several engines 142 stacked in layers as depicted here in dashed lines. The LC-based switch engine 142 has multiple control windows or arrays 144a-c arranged in a port direction (D). The ports 115 for the quad optical channel monitor 110 are optically coupled to a first of the control window 144a. The ports 165a-b of the wavelength selective switch units 160 are optically coupled to second and third of the control windows 144b-c respectively.

For the optical channels dispersed by the dispersion element 120, each of the control windows 144a-c includes a plurality of cells 146 arranged in the dispersion direction (D). These cells 146 can include one or more pixels of an LC switching engine or an LCoS switching engine 142 depending on the configuration, the size of the individual pixels, and the like.

For illustrative simplicity, the integrated module 100 is shown for twin 1×2 wavelength selective switch (WSS) units 160a-b and a quad optical channel monitor 110. Each of the twin 1×2 WSS units 160a-b has three ports 165a-b in this example. The quad optical channel monitor unit 110 has multiple ports 115 (only some of which are shown) and multiple photodetectors (which are not shown) for performing optical channel monitoring as disclosed herein. As will be appreciated, the module 100 can be expanded with a duplication of elements. Moreover, various optical elements can be included as needed, such as polarization beam splitters, compensating optics, and the like.

Ports 165a, 165b, and 115 are shown respectively for the first WSS unit 160a, the second WSS unit 160b, and the quad OCM unit 110. Signals from these ports are optically coupled to the dispersion element 120, which can be a diffraction grating as noted. The signals pass through lensing 130 or the like to LC-based switch engine 142 of the assembly 140. Again, the assembly 140 can have one LC-based switch engine 142 or can have several engines 142 stacked in layers in the propagation direction of the light as noted herein. The switch engine 142 has multiple control windows or arrays 144a-c in the port direction. Each of the control windows 144a-c has cascaded cells 146 in the dispersion direction. The cells 146 are arranged in an array relative to the port direction (P) versus the dispersion direction (D). Depending on the switch engine, each cell 146 can be comprised of one or more individually operable pixels. The port direction (P) is arranged to match the arrangement of ports 115, 165a-b. The dispersion direction (D) is arranged to match the dispersion of the channels by the dispersion element 120.

In this way, both WSS units 160a-b has a group of input and output ports 165a-b with its own control windows 144b-c of the LC-based switch engine 142 of the switching assembly 140. All four optical channel monitors of the quad unit 110 share one control window 144a of the LC-based switch engine 142 of the switching assembly 140.

As shown in FIG. 7B, input light from any OCM or WSS input port 115, 165a-b is dispersed by the diffraction grating 120 and focused by the focal lensing 130 to the respective control windows 144a-c. For WSS routing, the light of selected wavelength channel(s) can be routed to one of the N output ports 165a-b. For OCM routing, only one wavelength channel is switched to the output port 115 at a time for the photodetector (not shown) to detect the integrated power in that channel, while all other channels are blocked. Sweeping the open channel allows the detection of the power of every channel.

During use, the module 100 is configured to receive incoming wavelength division multiplexed signals. The dispersion element 120 separates the signals into component wavelengths. The lensing 130 focuses the separate component channels onto the LC-based switching assembly 140, which has a reflective element that returns the light in reverse order back through the switching assembly 140, the lensing 130, and the dispersion element 120. The light is coupled back to the output ports 115, 165a-b via the coupling.

For optical channel monitoring, the signals are coupled to the optical switching performed by the control window 144a, which switches which signals are passed on to detection and processing functions of the optical channel monitors, which performs the primary spectral monitoring of the WDM channel spectrum.

For wavelength selective switching, the signals are coupled to the optical switching performed by the control windows 144b-c, which switches which signals are passed on for output. The WSS units 160a-b use the control windows 144b-c to dynamically route, block, and attenuate the channels in the DWDM signal. For example, each wavelength channel of the DWDM signal at an input port 165 can be switched (routed) to any one of the N output ports 165, and the routing can be performed independent of how any of the other wavelength channels are routed. A control interface with the module 100 either from an integrated controller 200 or external controller can dynamically change the wavelength switching (routing) performed by operating the switching assembly 140 integrated into the module 100. Although not shown, variable attenuation mechanisms can be used with the WSS units for each wavelength. This can allow the module to independently attenuate each wavelength as need to control power of the channels and equalize their outputs.

In this arrangement, the switching assembly 140 has three control windows 144a-c : two for the two WSS units 160a-b and one for the quad OCM unit 110. Each control window 144a-c supports N channels. More WSS and OCM units can be integrated in the module 100 with shared optical parts and control windows 144.

In the switching assembly 140, for example, each control window 144a-c has a 1xN array of cells 146, each of which can have one or more individually drivable pixels. Each of the cells 146 is arranged for one of the N wavelengths in the multiplexed signal being processed.

As noted, the switching assembly 140 can include an liquid crystal (LC) switching engines, a liquid-crystal-on-silicon (LCoS) switching engines, or a combination of both. The control windows 144a-c can have multiple pixels per optical channel. This can allow the grid of cells 146 to be configured for different channel widths, bit rates, etc.

Depending on the implementation and as noted previously, the switching assembly 140 can have more than one LC-based switching engine 142 with windows 144a-c of cells 146 aligned behind one another so that the light can be configured to pass through one or both of the engines 142. Every pixel in the arrays engines 142 can be individually drivable with a voltage, so that each wavelength can be independently steered. Wedge angles, prisms, or other optical corrections can be used for beam steering.

One or more reflective mirrors in the switching assembly 140 can be angled to direct reflected beams back along a desired path. The mirror angle can be configured so that the input beam and the reflected beam for a given port do or do not overlap. Overlap can minimize the number of ports and reduce the overall height of the module.

An optical circulator can be used to separate the output from the input for such a port having beam overlap.

As discussed previously and as shown again in FIG. 6, a controller 200 can control functions of the module 100, the optical channel monitoring, the wavelength selective switching, and the like. For example, the controller 200 can control the switching assembly 140, monitor the temperature of internal environment of the module 100, calibrate the spectral peaks of signals, set the temperature of internal environment (if active temperature control is included), etc. To perform the various functions, the controller 200 includes drivers for components like thermistors, thermoelectric coolers (TECs), and the like. As shown, the controller 200 may represent an internal controller of the module 100 itself. Additionally or alternatively, the controller 20 may represent a separate controller used elsewhere in an optical network.

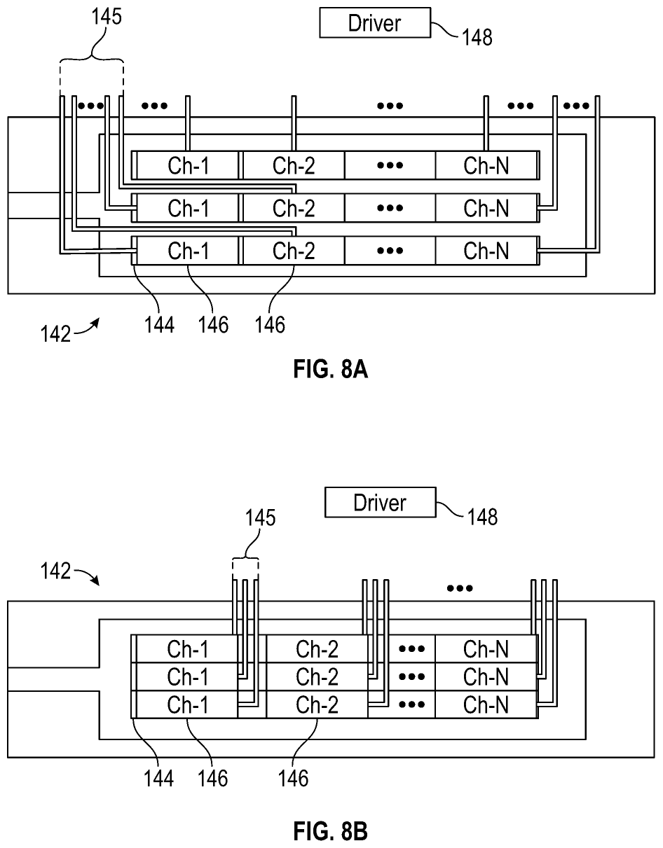

FIGS. 8A-8B illustrate a face of a switching assembly 140 having a switching engine 142 having control windows or arrays 144a-c with different configurations for electrical connection traces. FIG. 8A shows electrical connection traces going in between the control windows 144a-c, and FIG. 8B shows electrical connection traces going in between channel cells 146 of the control windows 144a-c.

In FIG. 8A, for example, the control windows 144a-c are separated by gaps on the face of the assembly's substrate. The electric connections from an engine driver 148 to the cells 146 of the control windows 144a-c can be routed in these gaps.

In FIG. 8B, the switch engines 144a-c are not separated by gaps. Instead, the cells 146 on each of the control windows 144a-c is separated by a space. The electric connections from an engine driver 148 to the cells 146 of the control windows 144a-c can be routed in these spaces. Other combinations of gaps and spaces can be used.

As disclosed herein, such as in FIGS. 6 and 7A-7B, the multiple wavelength selective switches (WSS) unit 160a-b and multi-port optical channel monitoring of the quad OCM unit 110 are integrated with a shared switching assembly 140 (e.g., having control windows 144) into the single module 100 to achieve low cost and compact size. In this way, the module 100 can perform wavelength selective switching and optical channel monitoring functionalities with the shared switching assembly 140. The switching assembly 140 combined with the wavelength selective switching can support high port counts. Also, the switching assembly 140 combined with the optical channel monitoring can measure integrated power in individual channels or combinations of channels. Together, the integration can achieve lower cost and more compact size.

In general, the scan speed of LC-based switching engines 142 may be slower than that of Digital Micromirror Device (DMD). However, applications in 5G and edge networks may have relaxed scan time requirements for optical channel monitoring. Scan times in excess of several seconds are being proposed. During use, all optical channel monitors may see the same channel from different ports at any given time. This may not be an issue for the proposed 5G and edge WSS applications because the function is to periodically monitor power level of all channels and sequence may not be important.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A module for handling optical beams in an optical network, each of the optical beams having a plurality of optical channels, the module comprising:
a wavelength selective switch having a first input port for a first of the optical beams;
an optical channel monitor having a second input port for a second of the optical beams;
a dispersion element integrated in the module and shared by the wavelength selective switch and the optical channel monitor, the dispersion element arranged in optical communication with the first and second optical beams from the first and second input ports and configured to disperse the respective first and second optical beams into the optical channels;
a switching assembly, the switching assembly arranged in optical communication with the optical channels from the dispersion element and configured to selectively reflect the optical channels back to the dispersion element, the switching assembly comprising at least one switch engine being liquid crystal based, the at least one switch engine having a first array of first cells and a second array of second cells, the first array arranged for the wavelength selective switch, the second array arranged for the optical channel monitor, each of the first and second cells being electrically switchable between first and second states;
a plurality of first output ports for the wavelength selective switch being arranged in optical communication with the dispersion element, the first output ports being configured to receive one or more of the optical channels selectively reflected from the switching assembly; and
a plurality of second output ports in optical communication with a one or more photodetectors for the optical channel monitor and being arranged in optical communication with the dispersion element, each of the one or more photodetectors being configured to receive one or more of the optical channels selectively reflected from the switching assembly.

2. The module of claim 1, wherein the one or more photodetectors comprise a plurality of photodetectors, the switching assembly being configured to selectively reflect the optical channels for parallel detection by the plurality of photodetectors.

3. The module of claim 1, wherein the one or more photodetectors comprise one of the photodetectors, the switching assembly being configured to selectively reflect the optical channels for sequential detection by the one photodetector.

4. The module of claim 1, wherein the one or more photodetectors comprise a plurality of the photodetectors, the switching assembly being configured to selectively reflect the optical channels for reconfigurable detection by the plurality of photodetectors.

5. The module of claim 1, further comprising:
a splitter, the splitter having a third input port for a third of the optical beams and having a plurality of third output ports associated therewith, the splitter splitting the third optical beam from the third input port into the plurality of third output ports; and
a combiner, the combiner having a fourth input port for a fourth of the optical beams and having a fourth output port associated therewith, the combiner combining the fourth optical beams from third input ports into the fourth output port.

6. The module of claim 1, wherein the at least one switch engine comprises a plurality of the at least one switch engine stacked together in a propagation direction of the optical beams.

7. The module of claim 1, further comprising another wavelength selective switch and having a third input port for a third of the optical beams,
wherein the dispersion element is arranged in optical communication with the third optical beam from the third input port and is configured to disperse the third optical beam into the optical channels across a dispersion direction; and
wherein the at least one switch engine comprises a third array of third cells, and being electrically switchable between the first and second states.

8. The module of claim 7, further comprising a plurality of third output ports arranged in optical communication with the dispersion element and being configured to receive one or more of the optical channels selectively reflected from the third array of the switching assembly for wavelength selective switching of one or more of the optical channels for the third optical beam.

9. The module of claim 1, further comprising:
another optical channel monitor integrated in the module and having a third input port for a third of the optical beams,
wherein the dispersion element is arranged in optical communication with the optical beams from the third input port and is configured to disperse the third optical beam into the optical channels; and
wherein the at least one switch engine comprises a third array of third cells being electrically switchable between the first and second states.

10. The module of claim 9, further comprising third output ports in optical communication with one or more photodetectors for the other optical channel monitor, the third ports being configured to receive one of the optical channels selectively reflected from the third array of the switching assembly for optical channel monitoring of a respective one or more of the optical channels for the third optical beam.

11. The module of claim 1, wherein the ports each comprises a fiber optically coupled to a collimator.

12. The module of claim 1, wherein the dispersion element comprises a diffraction grating.

13. The module of claim 12, wherein the dispersion element comprises a lens arranged between the diffraction grating and the switching assembly.

14. The module of claim 1, wherein the at least one switch engine comprises:
a liquid crystal switch engine having pixels on a glass substrate; or
a liquid-crystal-on-silicon (LCoS) switch engine having pixels on a silicon substrate.

15. The module of claim 14, wherein each of the first cells comprises one or more of the pixels.

16. The module of claim 1, comprising a housing having the first and second input ports for the optical beams and having the first and second output ports, the housing enclosing the wavelength selective switch, the optical channel monitor, the dispersion element, the switching assembly, and the one or more photodetectors.

17. The module of claim 1, further comprising a controller disposed in operable communication with the switching assembly and the one or more photodetectors.

18. The module of claim 1, wherein the first array and second array are arranged, respectively, in a port direction, and each of the first cells and second cells are each arranged in the dispersion direction, respectively within the first and second arrays, for respective ones of the optical channels, and each of the cells in the first state configured to at least pass the respective optical channel, each of the cells in the second state configured to at least attenuate the respective optical channel.

19. The module of claim 18, wherein the at least one switch engine comprises a plurality of the at least one switch engine stacked together in a propagation direction of the optical beams.
